(19) United States
(12) Patent Application Publication
(10) Pub. No.: US 2014/0078400 A1
(43) Pub. Date: Mar. 20, 2014

(54) LOW COMPLEXITY SYNCHRONOUS CONTROL OF VIDEO PROCESSING USING VIDEO INFORMATION IN IN-BAND PORTIONS OF VIDEO

(71) Applicant: GENERAL INSTRUMENT CORPORATION, Horsham, CA (US)

(72) Inventors: Venkatram Vajjhula, San Diego, CA (US); Shivkumar Jayaraman, Cupertino, CA (US); Pierre Seigneurbieux, Mountain View, CA (US)

(73) Assignee: GENERAL INSTRUMENT CORPORATION, Horsham, CA (US)

(21) Appl. No.: 13/623,552

(22) Filed: Sep. 20, 2012

(51) Int. Cl. H04N 5/14

(52) U.S. Cl. 348/571; 348/E05.062

(57) ABSTRACT

A method for processing a video stream includes receiving the video stream at a first video processing circuit, and generating video information for the video stream by the first video processing circuit. The method further includes inserting the video information into an in-band portion of the video stream by the first video processing circuit, and transmitting the video stream with the video information in the in-band portion from the first video processing circuit to a second video processing circuit. The method further includes reading the video information from the in-band portion of the video stream by the second video processing circuit, and processing the video stream by the second video processing circuit using the video information in the in-band portion of the video stream. The method further includes transmitting the video stream with the video information in the in-band portion from the second video processing circuit for additional processing.

### BACKGROUND

Video processing systems include a number of processing modules for processing video prior to the video being supplied to a media device for consumption. A video processing system's processing modules may include a number of video processing integrated circuits (ICs) that provide multiple processing steps for video preprocessing, video encoding, video transcoding, video compressing, etc. The Numerous processing steps performed by the video processing ICs need to be synchronized and would require the synchronous receipt of control signals. For example, several encoding ICs included in a video processing system may process frames in parallel and require the synchronous receipt of control signals for synchronous processing of frames.

For a single video stream processing system which has two or more video processing ICs, providing control signals for synchronization between the video processing ICs may be possible if the number of video processing systems are relatively, such as one or two. If the number of video processing ICs in a video processing system is relatively large, providing the control signals synchronously is relatively complicated. Using dedicated ICs that provide control signals for inter chip communication can ease the problem to some extent. In order to use this method the video processing ICs should have dedicated input/outputs (PINS) for receiving and setting the control signals. The use of dedicated pins on the video processing ICs is often not a good solution because of availability of such pins on the video processing ICs as well the extra real estate required on a circuit board to accommodate the control signal IC. Regardless of whether a dedicated control IC is used, providing pin based control signals becomes complex as the number of video processing ICs in a system increases. Therefore, providing frame-accurate synchronous control signals remains difficult in larger systems (e.g., two or mode video processing systems working in parallel or series).

Video processing systems that process and generate multiple video streams in parallel often include a relatively large number of video processing ICs. In such cases, even using a dedicated IC for providing the control signals is not feasible. In these video processing systems, regardless of whether a dedicated IC is used for providing control signals synchronously, the delivery of the control signals from the controller to each individual video processing IC will not be sufficiently synchronous to achieve frame accurate processing and frame accurate alignment of the video streams.

### SUMMARY

According to one embodiment, a method for processing a video stream includes receiving the video stream at a first video processing circuit, and generating video information for the video stream by the first video processing circuit. The method further includes inserting the video information into an in-band portion of the video stream by the first video processing circuit, and transmitting the video stream with the video information in the in-band portion from the first video processing circuit to a second video processing circuit. The method further includes reading the video information from the in-band portion of the video stream by the second video processing circuit, and processing the video stream by the second video processing circuit using the video information in the in-band portion of the video stream. The method further includes transmitting the video stream with the video information in the in-band portion of the video stream from the second video processing circuit.

According to another embodiment, a method for synchronously processing a plurality of video streams includes receiving the plurality of video streams respectively at a plurality of video processing circuits, and reading video information from in-band portions of the plurality of video streams respectively by the plurality of video processing circuits. The method further includes processing the plurality of video streams by the plurality of video processing circuits using the video information from the in-band portions of the plurality of video streams, and transmitting the plurality of video streams with the video information in the in-band portions of the plurality of video streams respectively from the plurality of video processing circuits.

According to another embodiment, a video processing system for synchronously processing a plurality of video streams includes a set of video processing circuits for respectively: receiving the plurality of video streams; rereading video information from in-band portions of the plurality of video streams; synchronously processing the plurality of video streams using the video information in the in-band portions of the plurality of video streams beginning at a selected video frame of the plurality of video streams; and transmitting the plurality of video streams with the video information in the in-band portions of the plurality of video streams from the set of video processing circuits.

The following detailed description and accompanying drawings provide a more detailed understanding of the nature and advantages of the present invention.

### BRIEF DESCRIPTION OF THE DRAWINGS

FIG. 1 depicts an example of a video processing system according to one embodiment.

FIG. 2 depicts a high-level flow diagram of a video processing method according to one embodiment.

FIG. 3 depicts a high-level flow diagram of a video processing method according to another embodiment.

### DETAILED DESCRIPTION

Described herein are techniques for synchronously processing video streams at a frame accurate level. In the following description, for purposes of explanation, numerous examples and specific details are set forth in order to provide a thorough understanding of particular embodiments. Particular embodiments as defined by the claims may include some or all of the features in these examples alone or in combination with other features described below, and may further include modifications and equivalents of the features and concepts described herein.

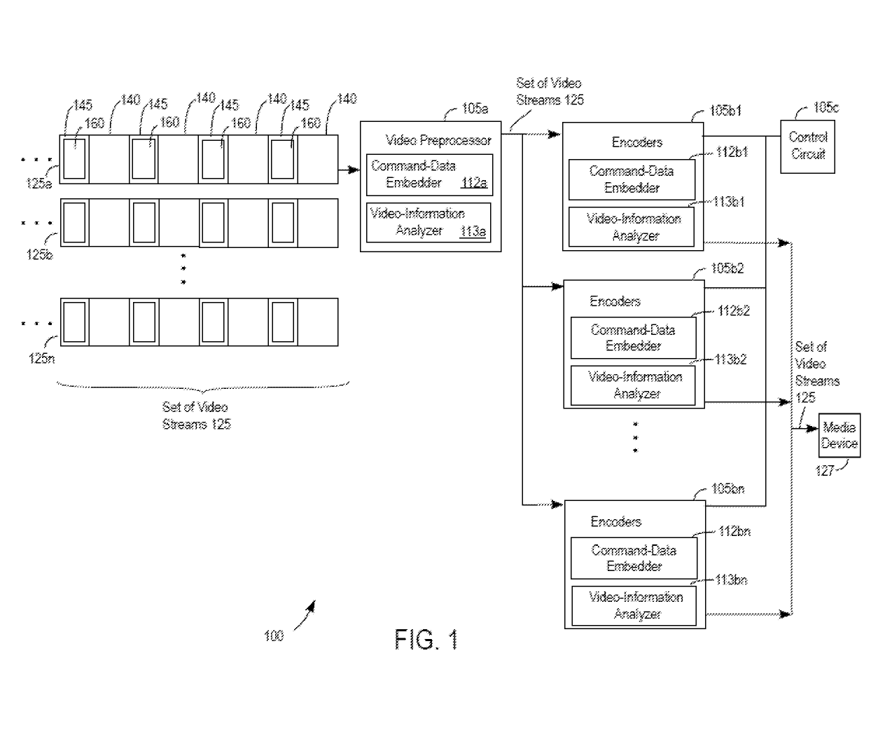

FIG. 1 depicts a video processing system 100 according to one embodiment. Video processing system 100 processes video streams of a video for play back of the video streams by media devices. Video processing system 100 may be at a headend or at an intermediary node in a network between the headend and the media devices that consume the video streams processed by the video processing system. For example, video processing system 100 may be in the “last mile” of video distribution to media devices that consume video. Video system 100 may alternatively be a distributed system where various portions of the system reside at a headend, other portions reside at intermediary nodes, or in media devices. A video stream may be a movie, a television show, program, or the like.

According to one embodiment, video processing system 100 includes a set of video processing circuits 105 that process a set of video streams of a video where the video streams are in different formats. A set as referred to herein may include one or more elements. The different formats of video streams processed by video processing system 100 may have different resolutions, bitrates, etc.

According to one embodiment, the set of video processing circuits 105 includes a video preprocessor 105a and a set of encoders 105b. Also, video processing system 100 may include a control circuit 105c for controlling the set of encoders 105b. The set of video processing circuits 105 might include other video processing circuits, such as transcoders and the like. Video preprocessor 105a, encoders 105b, and control circuit 105c may include general purpose processors or application specific integrated circuits (ASICs). The number and types of video processing circuits included in the set of video processing circuits 105 is variable based on various factors, such as the complexity of the encoding that video processing system 100 performs. For example, the set of encoders 105b may include specialty encoders for specialty encoding. An example of a specialty encoder is a face recognition encoder that recognizes faces and encodes the faces so that video streams processed by video processing system 100 have relatively clear faces (relatively high resolution), whereas a background behind the faces might have lower resolution. Another example of a specialty encoder is a high-speed encoder configured to encode video in which objects move at high speeds, such a video of sports.

As briefly described above, video system 100 may be a distributed system where various portions of the system reside at a headend, other portions reside at intermediary nodes, or in media devices. For example, video preprocessor 105a may be at a headend, whereas the set of encoders 105b and control circuit 105c may be at an intermediary node or in a media device that consumes video. If video system 100 is a distributed system, various video processing circuits 105 may communicate via a network, which may include internets, the Internet, or the like.

According to one embodiment, video preprocessor 105a receives a set of video streams 125 on which various video preprocessing is to be performed. The set of video streams 125 may include raw video streams or compressed video streams on which previous video processing has been previously performed. After preprocessing the set of video streams 125 by video preprocessor 105a, video preprocessor may transfer the set of video streams 125 to the set of encoders 105b for encoding the set of video streams into various compressed formats. After encoding and/or transcoding, the sets of video streams 125 may be consumed by a set of media devices 127.

Each video stream 125 includes a number of frames 140 and a number of in-band portions 145. In-band portions 145 of the set of video streams 125 include non-active video lines between video frames 140. Each video frame 140 may be associated with one in-band portion 145. According to one embodiment, one or more in-band portions 145 include video information 160. Video information 160 in in-band portions 145 may be arranged in header regions, payload regions, and the like.

According to one embodiment, each video processing circuit 105 included in the set of video processing circuits 105 includes a command-data embedder 112. Each command-data embedder 112 may insert video information 160 into in-band portions 145 and may read video information 160 from in-band portions 145. Command-data embedders 112 may recognize video information 160 in in-band portions 145 via the headers, via specific bit locations in in-band portions 145, etc. Video information 160 may include commands and/or data that one or more video processing circuits 105 may use for processing the set of video streams 125. Video information 160 is described in further detail below.

Each command-data embedder 112 may transmit forward video information 160 received by the command-data embedder in each video stream 125. That is, any video information 160 in a video stream received by one of the video processing circuit's command-data embedder 112 may be transmitted from the video processing circuit by the video processing circuit's command-data embedder 112. Video information 160 transmitted forward by a command-data embedder 112 may be used by subsequent video processing circuits 105 for video processing. For example, video preprocessor 105a may receive the set of video streams 125 where one or more of the video streams includes video information 160. Command-data embedder 112a of video preprocessor 105a may read video information 160 from the set of video streams 125, and transmit forward the video information in the set of video streams 125 to the set of encoders 105b, which may use the video information for video processing. Command data embedders 112 of the set of encoders 105b may similarly transmit forward video information 160 in the set of video streams 125. Video processing circuits that do not include command-data embedders 112 described herein may not recognize video information 160 in the set of video streams 125, might not transmit the video information forward.

According to one embodiment, each command-data embedder 112 includes a video-information analyzer 113 that analyzes video information 160 read by the command-data embedder. Each video-information analyzer 113 may determine whether received video information 160 (or a portion of video information 160) is to be used by the particular video processing circuit 105 that includes the video-information analyzer. If a selected video-information analyzer 113 determines that received video information 160 (or a portion of video information 160) is supposed to be used by a selected video processing circuit 105 that includes the selected video-information analyzer, the selected video-information analyzer may route the video information (or portion of video information) to the appropriate circuits of the selected video processing circuit for use.

According to one embodiment, at least one video processing circuit 105 (i.e., a selected video processing circuit, such as video preprocessor 105a) is configured to generate video information 160, and the command-data embedder 112 of the selected video processing circuit 105 inserts video information 160 into one or more in-band portions 145 of the set of video streams 125. Video information 160 generated by the selected video processing circuit 105 and transmitted in the set of video streams 125 from the selected video processing circuit 105 may be read and used by one or more other video processing circuits 105 (e.g., the set of encoders 105b) that receive the set of video streams 125. The one or more other video processing circuits 105 may be disposed down the line from the selected video processing circuit 105 that generated video information 160.

As described briefly above, video information 160 may include a set of commands and/or data. A command may be used by one or more video processing circuits 105 for processing the set of video streams 125. A command, for example, may be for process starting, process ending, splicing, or nearly any process that one of video processing circuits 105 may perform at that video frame or video field, or on all video frames or video fields from a given point forward while processing the set of video streams 125.

According to one embodiment, the same command may be placed on the same in-band portion (e.g., an nth in-band portion) 145 for the same video frame (e.g., an nth video frame) 140 in each video stream 125. For example, a start processing command may be placed in a first in-band portion 145 for a first video frame 140 of each video stream 145 so that each video processing circuit 105 that uses the start processing command, starts processing on the same video frame (e.g., the first video frame). According to a further example, a stop processing command may be placed in a last in-band portion 145 for a last video frame 140 of each video stream 125 so that each video processing circuit 105 that uses the stop processing command, stops processing on the same video frame (e.g., the last video frame). Starting and stopping the processing of video streams 125 on the same start frame and the same stop frame, for example, in the set of video streams 125 provides for simplification in synchronized processing of the set of video streams. More generally, providing the same command on a selected in-band portion 145 for a selected video frame 140 in each of video streams 125 provides that the processing (start, stop, scene change, etc.) for each selected video frame may be performed synchronously by one or more video processing circuits 105 that use the command. That is, video processing circuits 105 using the command may synchronize processing at a frame accurate level based on the command, and not based on the synchronous receipt of an out of band signal. An out of band signal is a signal that is not a portion of a video stream. For a video processing system, such as video processing system 100, that process a number of video streams, the use of out of band commands applied synchronously to a set of video processing circuits of the video processing system are often not sufficiently synchronous to provide for frame accurate synchronous processing.

Data included in video information 160 may be generated by one or more of video processing circuits 105 and may be used by one or more down the line video processing circuits 105 for processing the set of video streams 125. According to one embodiment, data included in video information 160 includes statistical data generated by one or more of video processing circuits 105, such as selected encoder included in the set of encoders 105b. The statistical data may relate to video processing performed by the selected encoder and may be used by a down the line encoder 150b to enhance the encoding performed by the down the line encoder. Sharing data (e.g., statistical data) in video information 160 between video processing circuits 105 provides the video processing circuits may operate interactively to limit redundant processing performed by the video processing circuits and to enhance processing performed by the video processing circuits. By providing for the sharing of data in video information 160, some video processing circuits 105 may not have to be configured to generate the data for their own use, and these video processing circuits may be simplified.

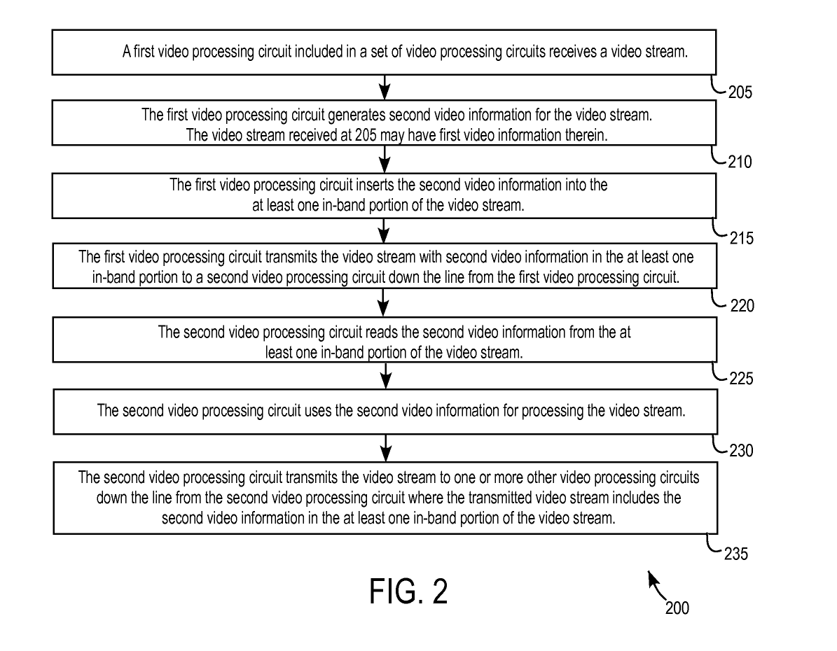

FIG. 2 depicts a high-level flow diagram 200 of a video processing method according to one embodiment. The high-level flow diagram represents one example embodiment and those of skill in the art will understand that various steps of the high-level flow diagram may be combined and/or added without deviating from the scope and the purview of the embodiment.

At 205, a first video processing circuit included in the set of video processing circuits 105 receives a video stream. The video stream may be a raw video stream or may be a compressed video stream previously processed by an encoder, a transcoder, or the like. The video stream may include first video information 160 in at least one in-band portion 145 of the video stream where the in-band portion is adjacent to a selected frame 140 of the video stream.

At 210, the first video processing circuit generates second video information 160 for the video stream. Second video information 160 may be a command for subsequent processing of the video steam, or may be data, such as statistical data generated by the first video processing circuit from processing the video stream. According to one embodiment, first video processing circuit 105 may generate a number of pieces of video information 160 as first video processing circuits 105 process the video stream and may insert the pieces of video information 160 into a number of in-band portions 145 of the video stream.

At 215, the first video processing circuit inserts the second video information 160 into the at least one in-band portion 145 (described at 205) of the video stream, and may insert the second video information 160 into other in-band portions 145 of the video stream. If first video processing circuit 105 generates a number of pieces of video information 160, first video processing circuit 105 may insert the number of pieces of video information 160 into a number of in-band portions 145 of the video stream.

At 220, the first video processing circuit transmits the video stream with second video information 160 in the at least one in-band portion to a second video processing circuit 105 included in the set of video processing circuits 105. If the video stream includes the first video information (described at 205), the first video processing circuit transmits the video stream with the first and second video information 160 in the at least one in-band portion of the video stream to second video processing circuit 105. According to one embodiment, the first video processing circuit may transmit the video stream to a number of video processing circuits down line from first video processing circuit 105.

At 225, the second video processing circuit reads second video information 160 from the at least one in-band portion of the video stream. If the video stream includes a number of pieces of video information 160 (e.g., the first and the second video information) in in-band portions of the stream, second video processing circuit 105 may read each piece of video information 160 as the video stream is processed by the second video processing circuit. If a number of video processing circuits 105 receive the video stream, the number of video processing circuits 105 may read video information 160, the number of pieces of video information, etc. from the video stream.

At 230, second video processing circuit 105 uses second video information 160 for processing the video stream. According to one embodiment, second video processing circuit 105 may determine whether second video information 160 is intended for use by second video processing circuit 105 prior to using the second video information 160 and may ignore second video information 160 if second video information 160 is not intended for use by second video processing circuit 105. Second video processing circuit 105 may similarly determine whether to use each piece of video information 160 (e.g., the first video information) second video processing circuit 105 reads from the in-band portions of the video stream prior to using or ignoring each of the pieces of video information 160. A number of video processing circuits 105 receiving the video stream may similarly use, and/or determine whether to use, one or more pieces of video information 160 in in-band portions of the video stream.

At 235, second video processing circuit 105 transmits the video stream to one or more other video processing circuits 105 down the line from second video processing circuit 105 where the transmitted video stream includes second video information 160 (and any other video information, such as the first video information 160) in the at least one in-band portion (or in-band portions) of the video stream. According to one embodiment, second video processing circuit 105 may generate additional video information 160 for the video stream and insert the additional video information 160 into one or more in-band portions of the video stream and transmit this additional video information 160 in the video stream for subsequent processing by other video processing circuits 105. The foregoing described method may be repeated by each additional video processing circuit that receives the video stream.

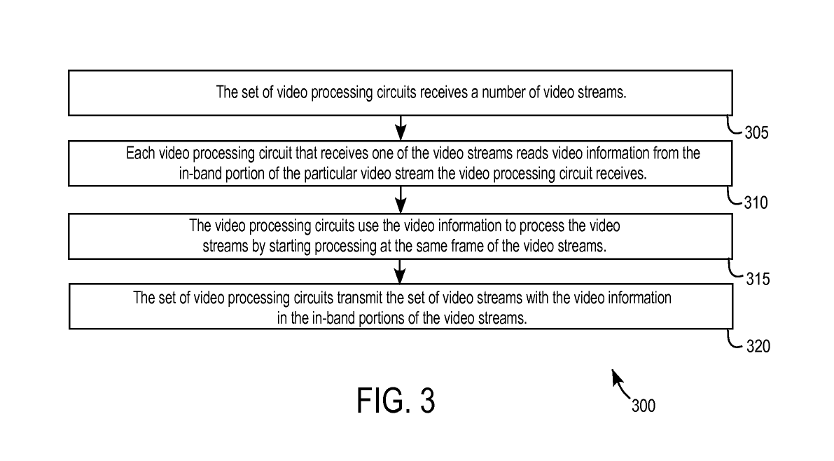

FIG. 3 depicts a high-level flow diagram 300 of a video processing method according to another embodiment. The high-level flow diagram represents one example embodiment and those of skill in the art will understand that various steps of the high-level flow diagram may be combined and/or added without deviating from the scope and the purview of the embodiment.

At 305, the set of video processing circuits 105 receives a number of video streams 125. The number of video streams 125 may be for a video (e.g., a movie, a television program, etc.) and may have different video formats, different bitrates, etc. for the video. Each video stream in the number of video streams 125 includes video information 160 at an in-band portion of a selected frame 145 of the number of video streams. Selected frame 145 may be the same frame in each of the number of video streams 125. That is, the selected frame is at the same temporal position of each video stream and includes substantially the same video data. For example, the selected frame may be a first I-frame of each of the number video streams 125.

At 310, each of the video processing circuits 105 that receive one of the video streams in the number of streams 125 reads the video information from the in-band portion of the particular video stream the video processing circuit receives.

At 315, each of the video processing circuits 105 uses video information 160 to process one or more frames of the particular video stream received by video processing circuit 105 starting at the same frame (which may be the selected frame). Because video information 160 is in an in-band portion for the selected frame for each of the video streams, video processing circuits 105 may use the selected frame as a reference point to begin using video information 160 to process the video streams starting at the same frame. Thereby, the video processing circuits 105 my process the number of video stream 125 synchronously and the same way, starting at the same frame. For example, if video information 160 is a start processing command in an in-band portion 145 of the first frame 140 of each of the video streams 125, the video processing circuits 105 may start processing video streams 125 synchronously starting at the first frame of each video stream.

At 320, the set of video processing circuits 105, via the command-data embedders 112, transmit the set of video streams 125 with video information 160 in in-band portions 145. Each video processing circuit 105 may generate additional video information as described above and insert additional video information 160 into one or more in-band portions of video streams 125 prior to transmission.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations, and equivalents may be employed without departing from the scope of the invention as defined by the claims.

1. A method for processing a video stream comprising:
receiving the video stream at a first video processing circuit;
generating video information for the received video stream by the first video processing circuit;
inserting the video information into an in-band portion of the video stream by the first video processing circuit; and
transmitting the video stream with the video information in the in-band portion from the first video processing circuit to a second video processing circuit, wherein the second video processing circuit is configured to read the video information from the in-band portion of the video stream, is configured to process the video stream using the video information in the in-band portion of the video stream, and is configured to transmit the video stream with the video information in the in-band portion of the video stream.

2. The method of claim 1 further comprising:
reading second video information from the in-band portion of the video stream by the first video processing circuit; and
determining by the first video processing circuit whether to use the second video information to process the video stream based on the second video information, wherein transmitting the video stream from the first video processing circuit to the second video processing circuit includes transmitting the video stream with the video information and the second video information in the in-band portion of the video stream from the first video processing circuit to the second video processing circuit.

3. The method of claim 2, wherein the second video processing circuit is configured to:
read the second video information from the in-band portion of the video stream by the second video processing circuit; and
determine whether to use the second video information to process the video stream based on the video information, wherein transmit the video stream with the video information in the in-band portion of the video stream from the second video processing circuit includes transmit the video stream with the video information and the second video information in the in-band portion of the video stream.

4. The method of claim 1, wherein the second video processing circuit is configured to:
generate second video information for the video stream; and
insert the second video information into the in-band portion of the video stream, wherein transmit the video stream with the video information in the in-band portion of the video stream from the second video processing circuit includes transmit the video stream with the video information and the second video information in the in-band portion of the video stream from the second video processing circuit.

5. The method of claim 4, wherein a third video processing circuit is configured to:
receive the video stream from the second video processing circuit;
read the video information and the second video information from the in-band portion of the video stream; and
determine whether to use the video information and the second video information to process the video stream based on the video information and the second video information.

6. The method of claim 1, wherein a third video processing circuit is configured to:
receive the video stream from the first video processing circuit;
read the video information from the in-band portion of the video stream; and
determine whether to use the video information to process the video stream based on the video information and the second video information.

7. The method of claim 1, wherein the second video processing circuit is configured to determine whether to use the video information to process the video stream based on the video information.

8. The method of claim 1, wherein the in-band portion of the video stream that includes the video information is adjacent to at least one video frame in the video stream and the video information is used to process the at least one video frame.

9. The method of claim 1, wherein the video information includes a command or data for processing the video stream.

10. The method of claim 9, wherein the video information is statistical information for at least one video frame of the video stream generated from encoding the video frame by the first video processing circuit.

11. A method for synchronously processing a plurality of video streams comprising:
receiving the plurality of video streams respectively at a plurality of video processing circuits;
reading video information from in-band portions of the plurality of received video streams respectively by the plurality of video processing circuits;
processing the plurality of received video streams by the plurality of video processing circuits using the video information from the in-band portions of the plurality of video streams; and
transmitting the plurality of video streams with the video information in the in-band portions of the plurality of video streams respectively from the plurality of video processing circuits.

12. The method of claim 11, wherein the video information in the in-band portions are for a selected video frame in each of the video streams in the plurality of video streams.

13. The method of claim 12, wherein the in-band portions are adjacent to the selected video frame in each of the video streams in the plurality of video streams.

14. The method of claim 12, further comprising synchronously processing the selected video frame for the plurality of video streams by the plurality of video processing circuits using the video information in the in-band portions of the plurality of video streams beginning at the selected video frame.

15. The method of claim 12, further comprising synchronously processing the plurality of video streams respectively by the plurality of video processing circuits using the video information in the in-band portions of the plurality of video streams beginning at the selected video frame.

16. The method of claim 11, further comprising:
generating the video information for the plurality of video streams by another video processing circuit;
inserting the video information into the in-band portions of the plurality of video streams by the another video processing circuit; and
transmitting the plurality of video streams with the video information in the in-band portions from the another video processing circuit to the plurality of video processing circuits.

17. The method of claim 11, wherein the video information includes a command or data for processing the plurality of video streams by the plurality of video processing circuits.

18. A video processing system for synchronously processing a plurality of video streams comprising:
a set of video processing circuits for respectively:
receiving the plurality of video streams;
reading video information from in-band portions of the plurality of received video streams;
synchronously processing the plurality of received video streams using the video information in the in-band portions of the plurality of video streams beginning at a selected video frame of the plurality of video streams; and
transmitting the plurality of video streams with the video information in the in-band portions of the plurality of video streams from the set of video processing circuits.

19. The video processing system of claim 18, wherein the in-band portions are adjacent to the selected video frame in the plurality of video streams.

20. The video processing system of claim 18, wherein the set of video processing circuits are for further respectively:
generating second video information for the plurality of video streams; and
inserting the second video information into the in-band portions of the plurality of video streams, wherein transmitting the plurality of video streams with the video information in the in-band portions of the plurality of video streams includes transmitting the plurality of video streams with the video information and the second video information in the in-band portions of the plurality of video streams.
